(19) United States
(12) Patent Application Publication
(10) Pub. No.: US 2007/0297392 A1
(43) Pub. Date: Dec. 27, 2007

(54) Method For Controlling A Gateway By Means Of A Protocol Arranged Therebetween And Gateway For Carrying Out Said Method

(75) Inventors: Frank Paetsch, Berlin (DE); Christian Marhoff, Berlin (DE)

Correspondence Address: NOVAK DRUCE DELUCA & QUIGG, LLP, 1300 EYE STREET NW, SUITE 1000 WEST TOWER, WASHINGTON, DC, 20005, US

(73) Assignee: TELES AG INFORMATIONSTECHNOLOGIEN, Berlin, DE (DE)

(21) Appl. No.: 11/814,622

(22) PCT Filed: Dec. 9, 2005
(86) PCT No.: PCT/DE05/02244

§ 371 Date: Aug. 8, 2007

(30) Foreign Application Priority Data
Feb. 10, 2005 (DE) 10 2005 006 631.3

(51) Int. Cl. H04L 12/66; H04M 7/00; H04Q 3/00

(52) U.S. Cl. 370/352

(57) ABSTRACT

The invention relates to a method for controlling a gateway which joins together a first communication network (6) and a second communication network (4). The second communication network (4) comprises a first protocol which is used to signal connections, the gateway (3-5) comprises a first interface (20,40) for the first communication network (6) and a second interface (10, 30) for the second communication system (4). The first interface (20, 40) is controlled by control commands of a second protocol, and the gateway (3-5) forms the control command of the second protocol on signal commands of a third protocol, which are known to the first protocol and/or which can be integrated into the first protocol. As a result, the gateway (3-5) can be controlled by means of a signal command of the first a.

### DESCRIPTION

The invention relates to a method for controlling a gateway which joins together a first communication network and a second communication network. The invention also relates to a gateway for carrying out the method.

### BACKGROUND OF THE INVENTION

The keyword “NGN” (Next Generation Network) is understood to be a network architecture which integrates the functions of conventional public telephone networks and of the Internet and, in doing so, provides for the transmission of voice, images and data with equal access rights on the basis of packet switching technology by using a uniform signaling arrangement.

To implement an NGN network, use of so-called media gateway controllers, also called soft switches or call agents, is known which handle the control and connection switching of so-called media gateways. A media gateway is typically a network element which provides for a transition between a circuit-switched network such as the public switched telephone network (PSTN) and a packet-switched network such as, in particular, the Internet. In this arrangement, it is provided that the “intelligence” for controlling and routing connections is located outside such a media gateway and is implemented in an external entity, namely the media gateway controller mentioned. The intelligence for controlling and switching connections and services is thus logically separate from the transmission and the routing of data packets. This principle is also known from the familiar SS7 signaling arrangement.

A familiar protocol for controlling media gateways is the MGCP (media gateway control protocol) which is defined by the IETF and the ITU-T. The Megaco and H.248 protocols are further developments, Megaco being the IETF name and H.248 being the ITU-T name. The signaling logic is located in the media gateway controllers.

Using the MGCP protocol, an NGN network with MGCP protocol (also called MGCP network in the text which follows) is capable of controlling the data streams in a media gateway from a decentralized unit, the media gateway controller, or respectively of switching and routing such data streams and setting up and clearing down connections. This requires that the media gateways of an NGN network can send signaling data to the media gateway controller or, respectively, receive these from the latter. The MGCP protocol is able to interoperate with known signaling systems of other networks. In particular, the MGCP protocol is able to interoperate with the SS7 and DSS1 protocols of the public telecommunication network and convert for this purpose signaling data according to the SS7 and DSS1 protocols into corresponding signaling data according to the MGCP protocol, and conversely.

However, the problem may occur that a media gateway has an interface and has implemented on this interface control protocols which are not recognized by the MGCP network and with which it accordingly cannot interoperate for controlling the media gateway. This problem occurs, in particular, when individual or proprietary interfaces are implemented in a media gateway.

### OBJECT OF THE INVENTION

The present invention is based on the object of providing a method for controlling a gateway which joins together a first communication network and a second communication network, and a gateway for carrying out the method, which make it possible to implement uniform signaling from and to a media gateway controller independently of the interfaces present in a gateway.

### BRIEF DESCRIPTION OF THE INVENTION

According to the invention, this object is achieved by a method having the features of claim 1 and a gateway having the features of claim 10. Preferred and advantageous embodiments of the inventions are specified in the subclaims.

Accordingly, the gateway, according to the invention, has a first interface to a first communication network and a second interface to a second communication network. The first interface is controlled by means of control commands of a second protocol. The gateway maps the control commands of the second protocol onto signaling commands of a third protocol which are known to a first protocol which uses the second communication network and/or which can be integrated into the first protocol. The result is that the gateway can be controlled externally by means of signaling commands of the first protocol and by a media gateway controller of the second communication network. Naturally, the said mapping of control commands of the second protocol onto signaling commands of a third protocol can occur in both directions, i.e. control commands of the second protocol are mapped onto signaling commands of the third protocol and signaling commands of the third protocol are mapped onto control commands of the second protocol.

The solution according to the invention is thus based on the concept of simulating in the media gateway signaling which recognizes the protocol used by the media gateway controller and converts it into its own control and signaling commands or integrates it into its own control and signaling commands. This provides for uniform signaling to the media gateway controller without having to inform the media gateway controller about new interfaces. Instead, the number of administered interfaces to be signaled and the corresponding administration complexity of each individual signaling interface can be minimized.

An involvement of an existing media gateway controller for controlling a media gateway in conformance with the standard is achieved without the necessity of indicating and defining an additional interface for the media gateway controller. The solution according to the invention makes it possible that the signaling transmitted or received from a media gateway to the media gateway controller is always the same and independent of the interfaces actually used in the media gateway.

The first communication network is preferably a mobile radio network and the second communication network is the Internet, although the invention is not restricted to this in any way. The first interface is then a mobile radio interface which administers one or a plurality of mobile radio channels. In this arrangement, it is preferably provided that the gateway has a plurality of plug-in cards which provide for allocation to or registration in a mobile radio network, and a plurality of radio modules which in each case, together with a plug-in card, implement a mobile radio channel. The first interface controls the mobile radio channels. The plug-in cards are preferably constructed as SIM cards.

The third protocol is, for example, the SS7 protocol or the DSS1 protocol. In principle, however, any protocol known to the first protocol or to the media gateway controller can be used.

The first protocol used is preferably the MGCP protocol, the H.248 protocol, the Megaco protocol, the SIGTRAN protocol or the SIP-T protocol.

In a preferred embodiment, the gateway emulates signaling commands of the third protocol which do not have equivalence in the second protocol so that the first protocol can completely acquire and translate the signaling commands of the third protocol.

The invention is preferably used for controlling the connection of telephone calls or telephone messages, particularly for implementing VOIP telephony.

### DESCRIPTION OF A PREFERRED EXEMPLARY EMBODIMENT OF THE INVENTION

In the text which follows, the invention will be explained in greater detail by means of an exemplary embodiment, referring to the figures of the drawing, in which:

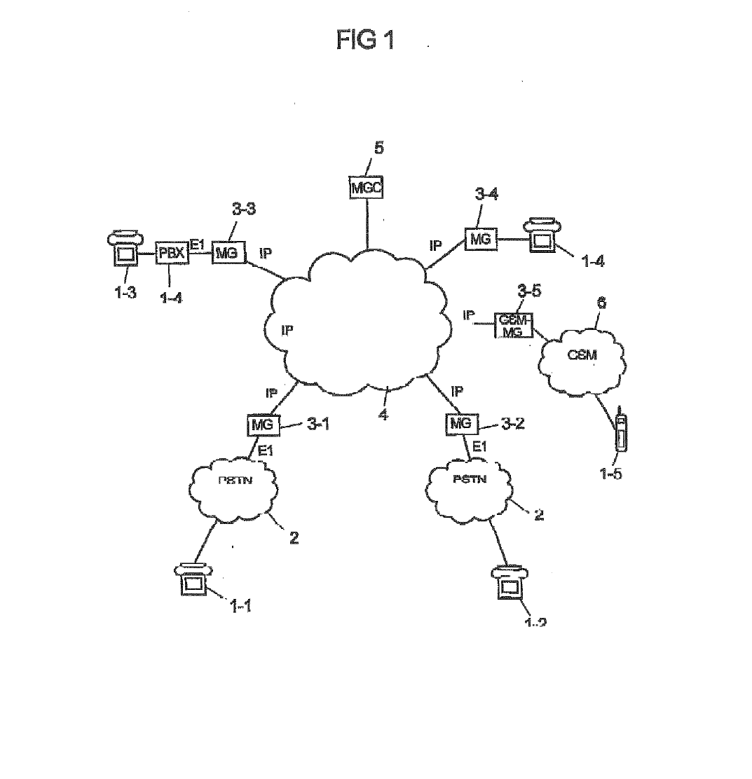

FIG. 1 shows an NGN network architecture for implementing uniform signaling between a media gateway and a media gateway controller;

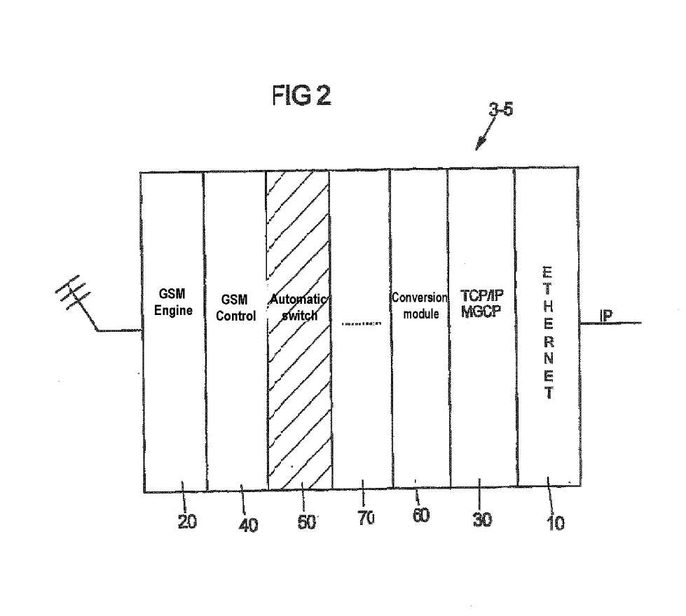

FIG. 2 shows an exemplary embodiment for implementing a mobile radio media gateway; and

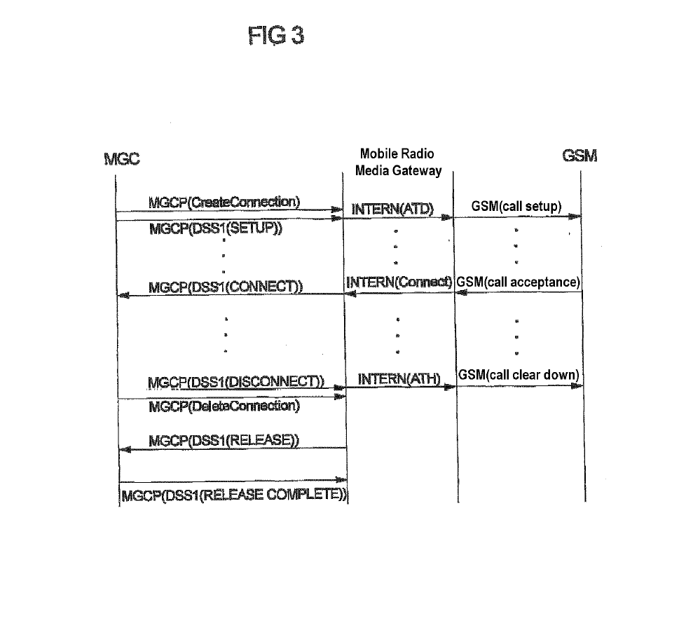

FIG. 3 shows a flow chart of the signaling during call setup and call clear down.

FIG. 1 shows the network architecture of an NGN network in one possible embodiment. A first terminal 1-1 is connected via a conventional subscriber line or ISDN connection, either directly or by interposition of a private branch exchange (not shown), to the public telecommunication network 2 or the local switching center of the public telecommunication network 2. The public telecommunication network 2 is a circuit-switching network and is also called PSTN (Public Switched Telephony Network).

The PSTN 2 is connected via a media gateway 3-1 to a network 4 in which data are transmitted packet-switched according to the IP protocol. In particular, this is the Internet. In this arrangement, the media gateway 3-1 terminates an El line of the PSTN 2 towards the PSTN. An El line has a bandwidth of 2048 Mbit/s and is subdivided into 30 B channels and one D channel. Towards the Internet 4, the media gateway 3-1 sends out IP packets or receives such. The media gateway 3-1 thus converts the data to be transmitted into IP data packets and sends them to the Internet 4. During this process, it is necessary to convert the signaling used in the PSTN network into signaling in the IP network. If necessary, the signaling channel is transported to a media gateway controller 5 with the aid of the MGCP protocol.

It is pointed out that the media gateway 3-1 does not itself handle signaling tasks (e.g. for connection setup and clear down) and control tasks (for routing the data to be transmitted or for controlling the channels involved) but that these are handled by a media gateway controller 5 which is also connected to the Internet 4. The media gateway controller 5 can consist of a number of modules which are contained in different computers.

The media gateway controller 5 performs soft switching of the media gateway 3-1 and handles all the signaling and control tasks for the media gateway 3-1. The corresponding signaling data are transmitted as data packets via the Internet 4.

Correspondingly, a further terminal 1-2 is connected to the PSTN 2 and from this to the Internet 4 via a media gateway 3-2. Furthermore, an arrangement is provided in which a terminal 1-3 is connected directly to a media gateway 3-3 via a private branch exchange 1-4 and via an E1 line. It is also provided that a terminal 1-4 is connected directly to a media gateway 3-4.

Finally, FIG. 1 shows an arrangement in which a mobile radio telephone 1-5 is connected via a mobile radio network 6 to a mobile radio media gateway 3-5 which, in turn, forms an interface to the Internet 4. The mobile radio network 6 is, for example, a GSM network but, in principle, can conform to any mobile radio standard.

The further media gateways 3-2, 3-3, 3-4, 3-5 are also controlled by the media gateway controller 5. Control is carried out by the MGCP protocol and corresponding protocol modules are contained in the media gateways 3-1, 3-2, 3-3, 3-4, 3-5.

Further terminals can be connected to the Internet 4, for example via WLAN technology or via DSL technology and corresponding media gateways, such media gateways also being controlled via the media gateway controller 5.

It is pointed out that the terminals 1-1, . . . , 1-5 are constructed as telephones only by way of example. In principle, the terminals can be any telecommunication terminals, particularly also PCs.

FIG. 2 shows a possible embodiment of the media gateway 3-5 shown in FIG. 1, which provides an interface between the GSM network 6 and the Internet 4.

The media controller 3-5 is a so-called mobile radio gateway which has a multiplicity of SIM cards and GSM radio modules, one SIM card and one radio module in each case providing one mobile radio channel. The media gateway 3-5 administers a multiplicity of such mobile radio channels. In this arrangement, it can also be provided that the mobile radio gateway 3-5 provides a network access to a plurality of different mobile radio networks, providing for this purpose SIM cards of different network operators.

From the point of view of the mobile radio network 6, the media gateway 3-5 is a facility with a multiplicity of mobile radio terminals since it has SIM cards and radio modules. As an alternative, it would also be possible to provide a connection from the Internet 4 into the mobile radio network 6 via a switching center of the mobile radio network 6. As a rule, this is associated with higher costs than the direct transmission “from terminal to terminal” of the mobile radio network. Such mobile radio gateways are described generally, for example, in EP 1 432 257 A1.

The media gateway 3-5 of FIG. 2 has a first IP interface 10, 30 to the IP network and to the Internet and a second interface 20, 40 to the GSM network. The first interface has a hardware module 10, for example an Ethernet module 10 or, as an alternative, for example, an ATM module or an xDSL module. Furthermore, it has a software module 30 which controls the data transmission via the hardware module 10 to and from the Internet. Data transmission via the Internet occurs, for example, on levels 3 and 4 of the OSI reference model according to the TCP/IP standard. Using an MGCP module of the module 20, the latter can communicate with the media gateway controller 5. Under this protocol, in particular, signaling commands are sent to and from the media gateway controller 5 which specify, for example, what address is provided for the data packets sent to the IP network.

The second interface 20, 40 to the GSM network also has a hardware module which has a number of GSM radio modules (also called GSM engines), and a required number of SIM cards. In each case, one radio module and one SIM card provide one mobile radio channel. The second interface also has a software module 40 which controls the mobile radio channels provided by the hardware module 20. For example, certain mobile radio channels are set up and cleared down. Communication between the software module 40 and the hardware module 20 takes place via a proprietary protocol (second protocol) which, for example, uses commands similar to the AT commands in modem programming. To this extent, the protocol is proprietary and does not correspond to “typical interfaces”, as the mobile radio gateway 3-5 provides, as explained, a network access to a mobile radio network by providing a multiplicity of “terminals” of the mobile radio network.

It is pointed out that the GSM media gateway 3-5 can optionally additionally have an automatic switch 50. This is appropriate, in particular, if the media gateway is additionally connected to a PSTN 2 (not shown in FIG. 1). The automatic switch then additionally acts as switch to the PSTN.

It is also pointed out that the media gateway 3-5 can have other components 70 which are not shown in detail. For example, the gateway 3-5 can additionally have a decoder/encoder which maps data for voice, SMS, etc. into IP packets or, respectively, for transmission via the GSM network.

The aim must now be for the media gateway controller 5 also to handle the complete control of the GSM media gateway 3-5 in accordance with the philosophy of soft switching. This requires that the MGCP protocol (first protocol) communicates with the GSM interface 20, 40 and takes over control of the GSM channels of the media gateway. However, this is not easily possible since the proprietary protocol of the interface is not recognized by the MGCP protocol and the GSM interface 20, 40 cannot send any signaling commands to the media gateway controller which are understood by it.

To eliminate this problem, the gateway 3-5 also has a conversion module 60. This converts the proprietary control commands of the interface 20, 40 into signaling commands of a protocol (third protocol) which is known to the MGCP protocol. For example, the corresponding control commands are converted into control commands according to the familiar SS7 or DSS1 (Q.931) protocols. The Q.931 protocol specifies the signaling in the ISDN. In the circuit-switching network itself, signaling takes place by means of the SS7 signaling system. The conversion module 60 converts not only the control commands of the GSM module into corresponding commands of the further protocol but, if necessary, generates additional signaling commands which are required in the further protocol, but are not contained in the proprietary protocol.

The conversion module 60 thus simulates and emulates signaling which is known to the MGCP protocol. In this process, messages are emulated which do not have equivalence in the proprietary set of commands.

The interface 30 and the MGCP module in it now recognizes the signaling commands of the further protocol provided by the conversion module 60. In this way, there can be signaling with the media gateway controller 5 and the latter can control, in particular, the mobile radio channels of the GSM interface.

As described, this is achieved by the fact that the control signals of the interface are mapped onto control signals of a protocol which is known to the MGCP protocol of the media gateway controller and with which it can communicate.

The architecture used makes it possible, for example, that calls via the GSM media gateway 3-5 are conducted as VOIP calls to the Internet 4 or VOIP calls are terminated by the GSM network, involving soft switching of the GSM media gateway 3-5 and of the GSM channels, respectively, via the media gateway controller 5. Instead of voice calls, other connections can also be implemented correspondingly such as, for example, for the transmission of SMS (short messaging service) or MMS (multimedia messaging service) messages.

FIG. 3 shows by way of example the signaling and control commands used in the protocols used for the case of a call from the packet-switched IP network 4 to a terminal of a GSM network 6. FIG. 3 shows the signaling between the media gateway controller 5, the mobile radio media gateway 3-5 and the GSM network 6 to which the called GSM terminating subscriber is connected. Between the media gateway controller 5 and the mobile radio gateway 3-5, data are transmitted in accordance with the MGCP protocol. Between the mobile radio gateway 3-5 and the GSM network, data are transmitted in accordance with a GSM signaling protocol. For controlling the mobile radio channels of the mobile radio gateway 3-5, an internal protocol is used which has local control commands INTERN (command).

As already explained, the internal control commands INTERN (command) are mapped in the conversion module 60 of the mobile radio gateway (compare FIG. 2) into signaling commands of a further protocol, the DSS1 protocol in the example shown, and are mapped onto local control commands of the mobile radio gateway in the reverse DSS1 signaling commands direction.

According to FIG. 3, the mobile radio gateway 3-5 receives a call from the packet-switched network 4. For this purpose, an MGCP message “MGCP (createconnection)” is sent to the mobile radio gateway for connecting a voice channel. The mobile radio gateway thereupon depacketizes and packetizes the voice channel (depending on the direction of transmission).

Furthermore, a DSS1 setup message, embedded in a further MGCP message “MGCP(DSS1(SETUP))”, is sent to the gateway. From the MGCP signaling command “MGCP(DSS1 (Setup))” received, the mobile radio gateway or the conversion module 60, contained therein, extracts the DSS1 command “DSS1(SETUP)” and converts it, together with the relevant parameters such as destination directory number and service features, into an internal control command “INTERN(ATD)”. This internal control command is used for controlling a GSM radio module of the interface 20. A GSM control command “GSM(call setup)” is then sent to the GSM network by the corresponding GSM radio module.

When the call has been accepted, corresponding signaling commands “GSM(call acceptance)”, “INTERN(Connect)” and “MGCP(DSS1(Connect))” are then sent in the reverse order to the mobile radio gateway 3-5 and to the media gateway controller 5. In the mobile radio gateway, the internal control command “INTERN(Connect)” of the proprietary gateway protocol is converted into the command “DSS1(Connect)”. The command “Connect” of the DSS1 protocol is transferred to the MGCP protocol and then sent as MGCP message “MGCP(DSS1(Connect))” to the media gateway controller 5.

In this context, it is pointed out that, in principle, the transferring or forwarding of the signaling command, simulated or emulated by the mobile radio gateway 3-5, of the further protocol to the MGCP protocol (or in the reverse direction) can take place in two ways. On the one hand, it can be provided that the control command of the further (third) protocol, the DSS1 protocol in the example, is mapped onto a corresponding control command of the (first) protocol of the media gateway controller, the MGCP protocol in the example, that is to say control commands of the corresponding protocols are again mapped or allocated. On the other hand, it can be provided that the control command of the further (e.g. DSS1) protocol is only embedded or integrated in an MGCP control command. For example, the MGCP control command provides a defined MGCP header which is then followed by the DSS1 control command as content of the data packet. In this variant, the MGCP protocol is only used for encapsulating the DSS1 control command in the transmission via the packet-switching network.

However, it is unimportant which one of these variants is used. It is only of importance that the signaling and control commands are transmitted between the media gateway controller and the mobile radio gateway in accordance with a suitable protocol, the MGCP protocol in the exemplary embodiment, the signaling commands of the further protocol (the DSS1 protocol in the example) are extracted from the MGCP commands or mapped by these and the signaling commands are furthermore mapped onto signaling commands of the internal mobile radio gateway protocol, or conversely.

FIG. 3 also shows the corresponding control commands during call clear down. The control command “MGCP(DSS1 (Disconnect))” is transmitted to the mobile radio gateway where it is converted into the control command “INTERN(ATH)” and a control command “GSM (call clear down)” is sent out to the GSM network. The command “MGCP (Delete(Connection))” disconnects the voice payload channel. This is followed by the commands “MGCP (DSS1(release))” and “MDCP(DSS1(Release Complete)”.

In its formulation, the invention is not restricted to the exemplary embodiment represented above. The only essential factor for the invention is that the control commands of an interface of a media gateway which cannot be understood initially by the protocol used by a media gateway controller are mapped onto corresponding control commands of a protocol known to the media gateway controller such as SS7 or DSS1 so that the media gateway controller can perceive control tasks of the media gateway.

1. A method for controlling a gateway which joins together a first communication network and a second communication network, wherein
the second communication network has a first protocol for signaling connections,
the gateway has a first interface to the first communication network and a second interface to the second communication network, and
the first interface is controlled by means of control commands of a second, protocol, the method comprising:
mapping the control commands of the second protocol onto signaling commands of a third protocol which are known to the first protocol and/or are integrated into the first protocol, and
controlling the gateway by using signaling commands of the first protocol.

2. The method as claimed in claim 1, wherein the second communication network is a packet switching network and the first protocol is used for externally controlling the gateway by means of a media gateway controller associated with the packet switching network.

3. The method as claimed in claim 2, wherein the first protocol used is the MGCP protocol, the H.248 protocol, the Megaco protocol, the SIGTRAN protocol or the SIP T protocol.

4. The method as claimed in claim 1, wherein the first communication network (6) is a mobile radio network and the second communication network is the Internet (4).

5. The method as claimed in claim 4, wherein the first interface is a mobile radio interface which administers one or a plurality of mobile radio channels.

6. The method as claimed in claim 3, wherein the gateway has a plurality of plug in cards which provide for allocation to or registration in a mobile radio network, and a plurality of radio modules which in each case, together with a plug in card, implement a mobile radio channel, wherein the first interface controls the mobile radio channels.

7. The method as claimed in claim 1, wherein the third protocol is the SS7 protocol or the DSS1 protocol.

8. The method as claimed in claim 1, wherein the method is used for controlling the connection of VolP telephone calls or telephone messages.

9. The method as claimed in claim 1, wherein the gateway emulates signaling commands of the third protocol which do not have equivalence in the second protocol, during the mapping of control commands of the second protocol onto signaling commands of the third protocol.

10. A gateway for carrying out the method as claimed in claim 1, comprising:
a mapper that maps control commands of said second, proprietary protocol of said first interface onto signaling commands of said third protocol.

11. The gateway as claimed in claim 10, wherein the mapper simulates and/or emulates the third protocol.

12. The gateway as claimed in claim 10, wherein the first protocol is used for externally controlling the gateway by means of a media gateway controller.

13. The gateway as claimed in claim 10 wherein the first interface is a mobile radio interface which administers one or a plurality of mobile radio channels.

14. The gateway as claimed in claim 13, wherein the gateway has a plurality of plug in cards which provide for allocation to and registration in a mobile radio network, and a plurality of radio modules which in each case, together with a plug in card, implement a mobile radio channel, wherein the first interface has means for controlling the mobile radio channels.

15. The gateway as claimed in claim 10, wherein the second interface is an IP interface.

16. The gateway as claimed in claim 10, wherein the means are provided by software.

17. The gateway as claimed in claim 10, wherein the gateway additionally has a decoder/encoder for voice and/or text messages.

18. The gateway as claimed in claim 10, wherein the gateway additionally has an automatic switch for switching circuit switched connections.

19. The gateway as claimed in claim 10, wherein the gateway is a mobile radio media gateway which joins together at least one mobile radio network and the Internet.
